(19) United States
(12) Patent Application Publication
(10) Pub. No.: US 2024/0421899 A1
(43) Pub. Date: Dec. 19, 2024

(54) OPTICAL COMMUNICATION DEVICE, OPERATING MACHINE, AND COMMUNICATION METHOD

(71) Applicant: FUJI CORPORATION, Chiryu (JP)

(72) Inventors: Daisuke NAKAMURA, Chiryu-shi (JP); Sota MIZUNO, Okazaki-shi (JP); Yoshihiro FUJITA, Chiryu-shi (JP)

(73) Assignee: FUJI CORPORATION, Chiryu (JP)

(21) Appl. No.: 18/703,587

(22) PCT Filed: Nov. 9, 2021
(86) PCT No.: PCT/JP2021/041131

§ 371 Date: Apr. 22, 2024

(51) Int. Cl. H04B 10/03; H04B 10/079; H04L 1/00

(52) U.S. Cl. CPC H04B 10/03; H04B 10/0791; H04B 10/07953; H04L 1/0042

(57) ABSTRACT

Provided are an optical communication device, an operating machine, and a communication method capable of detecting and notifying of occurrence of a communication failure or a possibility of the occurrence of a communication failure in optical communication.

An optical communication device includes an optical receiving device configured to execute optical communication using an optical signal; a detection device configured to detect an error of data in received data received by the optical receiving device; and a determination device configured to determine an increase in the number of times of detection of the error detected in the detection device, and make notification of notification information related to communication abnormality based on the determination that the number of times of detection has been increased.

### TECHNICAL FIELD

The present disclosure relates to an optical communication device that executes optical communication using an optical signal.

### BACKGROUND ART

Conventionally, various devices that transmit and receive data through optical communication have been proposed. For example, in an electric component mounting device of following Patent Literature 1, a control device and a Y-axis slide device are connected by an optical fiber cable, and optical communication using an optical signal is executed. The control device controls each device in the electric component mounting device based on data transmitted and received through optical communication.

### PATENT LITERATURE

Patent Literature 1: International Publication No. WO2015/052843

### BRIEF SUMMARY

### Technical Problem

In the communication device described above that executes optical communication, for example, when deterioration of a light emitting element or the optical fiber cable progresses, a communication failure state in which communication connection cannot be performed occurs. When a communication failure occurs, work such as exchanging of the optical fiber cable is required. Therefore, a technique capable of detecting the occurrence or a possibility of occurrence of a communication failure at an early stage is required.

The present disclosure has been made in view of the above problem, and an object of the present disclosure is to provide an optical communication device, an operating machine, and a communication method capable of detecting and notifying of occurrence of a communication failure or a possibility of the occurrence of a communication failure in optical communication.

### Solution to Problem

In order to solve the above problem, the present description discloses an optical communication device including an optical receiving device configured to execute optical communication using an optical signal: a detection device configured to detect an error of data in received data received by the optical receiving device; and a determination device configured to determine an increase in the number of times of detection of the error detected in the detection device, and make notification of notification information related to communication abnormality based on the determination that the number of times of detection has been increased.

In addition, content of the present disclosure is not limited to implementation of the optical communication device, and is hence extremely useful in implementation of an operating machine including the optical communication device or a communication method in the operating machine.

### Advantageous Effects

According to the optical communication device or the like of the present disclosure, when quality of the communication is degraded because of deterioration of a light emitting element or an optical fiber cable and the error of data is increased, it is possible to notify the user of the occurrence of a communication failure or a possibility of the occurrence of a communication failure by the notification information.

### BRIEF DESCRIPTION OF DRAWINGS

FIG. 1 is a plan view illustrating a schematic configuration of a component mounting system of the present example.

FIG. 2 is a perspective view illustrating a schematic configuration of a component mounter and a loader.

FIG. 3 is a block diagram of a multiplex communication system.

FIG. 4 is a diagram illustrating content of multiplexed data transmitted from a fixed section board to a mounting head in multiplex communication of an optical fiber cable.

FIG. 5 is a diagram illustrating content of multiplexed data transmitted from the mounting head to the fixed section board in the multiplex communication of the optical fiber cable.

FIG. 6 is a flowchart illustrating notification control processing by the component mounter.

FIG. 7 is a diagram illustrating an example of a display screen displayed on a touch panel in first notification processing.

FIG. 8 is a diagram illustrating an example of a display screen displayed on the touch panel in second notification processing.

### DESCRIPTION OF EMBODIMENTS

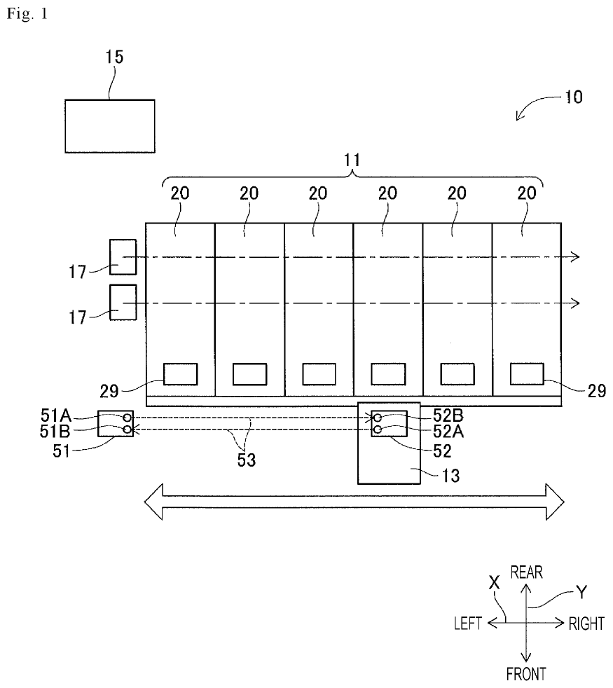

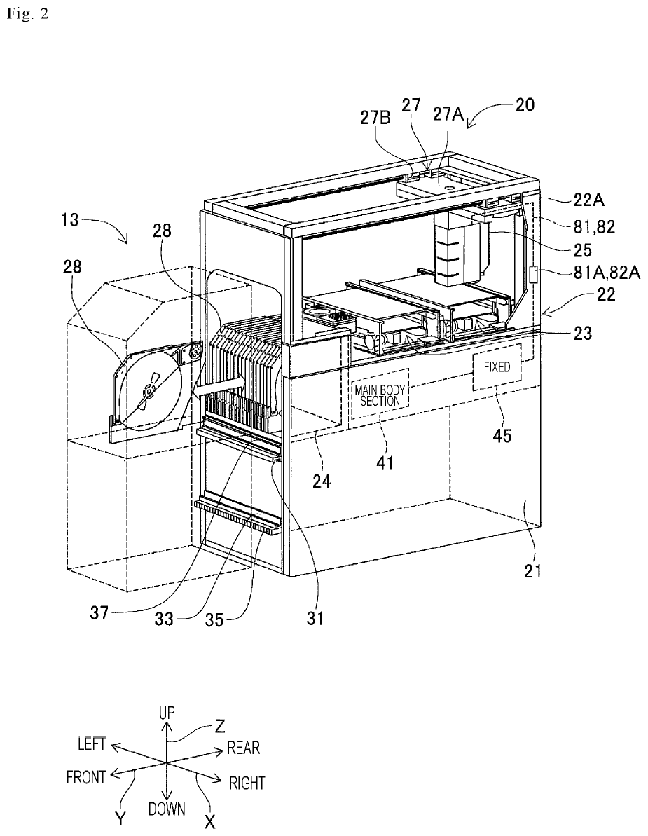

Hereinafter, an example in which an optical communication device of the present disclosure is specified will be described with reference to the drawings. FIG. 1 is a plan view illustrating a schematic configuration of component mounting system 10 of the present example. FIG. 2 is a perspective view illustrating a schematic configuration of component mounter 20 and loader 13. In the following description, a right-left direction in FIG. 1 is referred to as an X-axis direction, an up-down direction in FIG. 1 is referred to as a Y-axis direction (front-rear direction), and a direction perpendicular to the X-axis direction and the Y-axis direction is referred to as a Z-axis direction (up-down direction). The X-axis direction is a conveyance direction of board 17 described later, and the Y-axis direction is a direction parallel to a plane of conveyed board 17 and perpendicular to the X-axis direction.

As illustrated in FIG. 1, component mounting system 10 includes production line 11, loader 13, and host computer 15. Production line 11 includes multiple component mounters 20 arranged in the X-axis direction, and performs mounting or the like of an electronic component (not illustrated) on board 17. For example, board 17 is conveyed from left-side component mounter 20 to right-side component mounter 20, and the mounting or the like of an electronic component is executed on board 17 while board 17 is conveyed.

As illustrated in FIG. 2, component mounter 20 includes base 21 and module 22. Base 21 has a substantially rectangular parallelepiped shape elongated in the Y-axis direction and is placed on a floor or the like of a factory on which component mounter 20 is installed. A position of base 21 in the up-down direction is adjusted, for example, such that positions of board conveyance devices 23 of adjacent modules 22 are aligned with each other. Base 21 and base 21 of adjacent component mounter 20 are fixed to each other. Module 22 is a device that performs mounting or the like of an electronic component on board 17 and is placed on base 21. Module 22 can be pulled out toward a front side of base 21 in the front-rear direction, and can be exchanged with another module 22.

Module 22 includes board conveyance device 23, feeder base 24, mounting head 25, and head moving mechanism 27. Board conveyance device 23 is provided in module 22 and conveys board 17 in the X-axis direction. Feeder base 24 is a base provided on a front side of module 22 and having an L shape in side view. Feeder base 24 includes multiple slots (not illustrated) that are aligned in the X-axis direction. Feeder 28 for supplying electronic components is mounted in each of the slots of feeder base 24. For example, feeder 28 is a tape feeder for supplying the electronic components from a tape which accommodates the electronic components at a predetermined pitch. As illustrated in FIG. 1, operation section 29 for performing operation input to component mounter 20 is provided on an upper cover of module 22. FIG. 2 illustrates a state in which the upper cover and operation section 29 are removed.

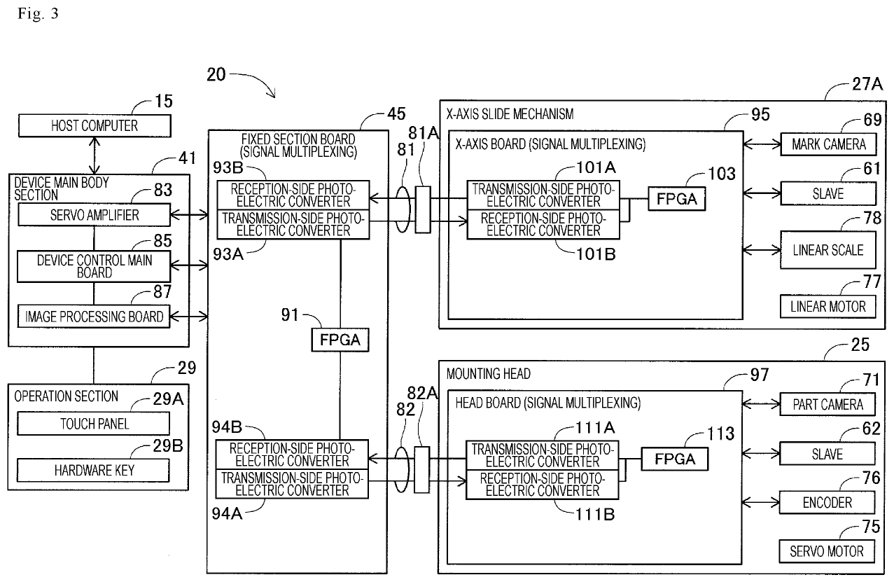

Mounting head 25 includes a holding member (not illustrated) that holds the electronic components supplied from feeder 28. As the holding member, for example, a suction nozzle to which a negative pressure is supplied to hold an electronic component, a chuck to grip and hold an electronic component, or the like can be employed. Mounting head 25 includes, for example, multiple servo motors 75 (refer to FIG. 3) as drive sources for changing an overall position of the multiple holding members or positions of the individual holding members. For example, the holding member rotates about a rotation axis parallel to the Z-axis direction based on driving of servo motor 75. Mounting head 25 mounts the electronic component held by the holding member on board 17.

Head moving mechanism 27 moves mounting head 25 to any position in the X-axis direction and the Y-axis direction in an upper portion of module 22. Specifically, head moving mechanism 27 includes X-axis slide mechanism 27A that moves mounting head 25 in the X-axis direction and Y-axis slide mechanism 27B that moves mounting head 25 in the Y-axis direction. X-axis slide mechanism 27A is attached to Y-axis slide mechanism 27B.

X-axis slide mechanism 27A includes slave 61 (refer to FIG. 3) that is connected to an industrial network. The industrial network here is, for example, EtherCAT (registered trademark). The industrial network of the present disclosure is not limited to the EtherCAT (registered trademark), and for example, other networks (communication standards) such as MECHATROLINK (registered trademark)-III and Profinet (registered trademark) can be adopted. Slave 61 is connected to various elements such as a relay and a sensor provided in X-axis slide mechanism 27A, and processes signals input to and output from the various elements based on control data received from device main body section 41 (refer to FIG. 3) of component mounter 20.

Y-axis slide mechanism 27B includes a linear motor (not illustrated) as a drive source. X-axis slide mechanism 27A moves to any position in the Y-axis direction based on driving of the linear motor of Y-axis slide mechanism 27B. In addition, X-axis slide mechanism 27A includes linear motor 77 (refer to FIG. 3) as a drive source. Mounting head 25 is attached to X-axis slide mechanism 27A, and moves to any position in the X-axis direction based on driving of linear motor 77 of X-axis slide mechanism 27A. Accordingly, mounting head 25 moves to any position in the X-axis direction and the Y-axis direction in module 22 in accordance with the driving of X-axis slide mechanism 27A and Y-axis slide mechanism 27B.

In addition, mounting head 25 is attached to X-axis slide mechanism 27A via a connector, is detachable by one touch, and can be changed to a different type of mounting head 25 such as a dispenser head, for example. Accordingly, mounting head 25 of the present example is detachable from component mounter 20. Mark camera 69 (refer to FIG. 3) for imaging board 17 is fixed to X-axis slide mechanism 27A in a state of facing downward. Mark camera 69 can image any position of board 17 from above in association with movement of head moving mechanism 27. Image data captured by mark camera 69 is transmitted from X-axis slide mechanism 27A to device main body section 41 through multiplex communication described later, and is subjected to image processing in image processing board 87 (refer to FIG. 3) of device main body section 41. Image processing board 87 acquires information relating to board 17 (such as a mark), an error of a mounting position, and the like by image processing.

Mounting head 25 includes slave 62 (refer to FIG. 3) connected to the industrial network described above. Various elements such as a relay and a sensor provided in mounting head 25 are connected to slave 62. Slave 62 processes signals that the various elements input to and output from mounting head 25 based on control data received from device main body section 41 (refer to FIG. 3). Mounting head 25 is provided with part camera 71 that images the electronic component held by the holding member. Image data captured by part camera 71 is transmitted from mounting head 25 to device main body section 41 through the multiplex communication, and is subjected to image processing in image processing board 87 (refer to FIG. 3) of device main body section 41. Image processing board 87 acquires an error of a holding position of the electronic component held by the holding member, and the like by image processing.

As illustrated in FIGS. 1 and 3, component mounter 20 includes operation section 29. Operation section 29 includes, for example, touch panel 29A and hardware key 29B, and functions as a user interface. Component mounter 20 outputs a signal corresponding to operation input received from a user through touch panel 29A or hardware key 29B to device main body section 41. Operation section 29 changes display content of touch panel 29A based on control of device main body section 41. The configuration of operation section 29 described above is an example. For example, operation section 29 need not include hardware key 29B. For example, operation section 29 may adopt such a configuration that operation section 29 is not provided and a display unit such as a liquid crystal screen and hardware key 29B are provided.

In addition, as illustrated in FIG. 2, upper guide rail 31, lower guide rail 33, rack gear 35, and non-contact power supply coil 37 are provided on a front surface of base 21. Upper guide rail 31 is a rail having a U-shaped cross section extending in the X-axis direction, and an opening section faces downward. Lower guide rail 33 is a rail having an L-shaped cross section extending in the X-axis direction, a vertical surface is attached to the front surface of base 21, and a horizontal surface extends forward. Rack gear 35 is a gear which is disposed below lower guide rail 33 and extending in the X-axis direction, and in which multiple longitudinal grooves are engraved on a front surface. Upper guide rail 31, lower guide rail 33, and rack gear 35 of base 21 can detachably be coupled to upper guide rail 31, lower guide rail 33, and rack gear 35 of adjacent base 21. Therefore, in component mounting system 10, the number of component mounters 20 aligned in production line 11 can be increased or decreased. Non-contact power supply coil 37 is a coil provided in an upper portion of upper guide rail 31 and disposed along the X-axis direction, and supplies power to loader 13.

Loader 13 is a device for automatically replenishing and recovering feeder 28 to and from component mounter 20, and includes a clamping section (not illustrated) for clamping feeder 28. Loader 13 is provided with an upper roller (not illustrated) inserted into upper guide rail 31 and a lower roller (not illustrated) inserted into lower guide rail 33. In addition, loader 13 has a motor serving as a drive source. A gear that meshes with rack gear 35 is attached to an output shaft of the motor. Loader 13 includes a power receiving coil that receives the power supplied from non-contact power supply coil 37 of component mounter 20. Loader 13 supplies the power received from non-contact power supply coil 37 to the motor. As a result, loader 13 can move in the X-axis direction (the right-left direction) by rotating the gear by the motor. Further, loader 13 can rotate the rollers in upper guide rail 31 and lower guide rail 33 to move in the X-axis direction while maintaining positions in the up-down direction and the front-rear direction.

Host computer 15 illustrated in FIG. 1 is, for example, a personal computer, and is a device that collectively manages component mounting system 10. A production program (so-called recipe) is stored in a storage device (HDD or the like) of host computer 15. In the production program, information such as a type, a mounting order, and a production number of components mounted in each component mounter 20 is set. Host computer 15 is connected to device main body section 41 of each component mounter 20 in a wired manner so as to be capable of bidirectional communication. For example, component mounter 20 starts mounting work of an electronic component based on the production program acquired from host computer 15. Component mounter 20 perform mounting work of an electronic component by mounting head 25 while conveying board 17.

Host computer 15 is connected to optical signal transceiver 51 that is a communication device for communicating with loader 13. As illustrated in FIG. 1, optical signal transceiver 51 includes light emitting element 51A and light receiving element 51B, and is installed on an upstream end portion of production line 11. Further, loader 13 includes an optical signal transceiver 52 capable of communicating with optical signal transceiver 51, for example, in an upper portion of the device. Optical signal transceiver 52 includes light emitting element 52A and light receiving element 52B. Light emitting element 51A and light receiving element 51B of optical signal transceiver 51 are respectively connected to light receiving element 52B and light emitting element 52A of optical signal transceiver 52 of loader 13 via optical wireless communication path 53 using an optical signal so as to be capable of wireless communication. Optical signal transceiver 51 is capable of bidirectional communication with optical signal transceiver 52 via optical wireless communication path 53. Optical wireless communication path 53 is a path along the X-axis direction, that is, a direction in which the multiple component mounters 20 are arranged. While moving from a left end to a right end of production line 11, loader 13 can communicate with optical signal transceiver 52, that is, host computer 15 via optical wireless communication path 53. As the optical signal, for example, visible light can be used, but other optical signals such as infrared light may be used.

Host computer 15 transmits, for example, data of an operation instruction to loader 13 via optical wireless communication path 53. Loader 13 determines an exchange operation, a movement destination, and the like of feeder 28 based on the data received by optical signal transceiver 52. Loader 13 transmits various I/O data, error information, and the like to host computer 15 via optical wireless communication path 53. Host computer 15 executes determination on control content of loader 13, error handling processing, or the like based on the data received via optical signal transceiver 51.

In addition, host computer 15 monitors the number of remaining electronic components of feeder 28. For example, when it is determined that feeder 28 needs to be replenished, host computer 15 displays, on a screen, an instruction to set feeder 28 accommodating a component type that needs to be replenished on a table (not illustrated) provided on an upstream side of production line 11. The user checks the screen, and sets feeder 28 on the table. When host computer 15 detects that desired feeder 28 is set on the table, host computer 15 instructs loader 13 to start the replenishment work via optical wireless communication path 53. After receiving feeder 28 from the table, loader 13 moves to the front of component mounter 20 that has received the instruction, and mounts feeder 28 received from the table in the slot of feeder base 24. In this manner, new feeder 28 is replenished to component mounter 20. In addition, loader 13 grips feeder 28 that has run out of the component with the clamping section, pulls out feeder 28 from feeder base 24, recover feeder 28, and discharges feeder 28 to the table. In this way, replenishment of new feeder 28 and recovery of feeder 28 that has run out of the component can be automatically performed by loader 13.

### (Configuration of Component Mounter 20)

Next, a multiplex communication system provided in component mounter 20 will be described. As illustrated in FIG. 2, component mounter 20 includes device main body section 41 and fixed section board 45 in module 22. Device main body section 41 and fixed section board 45 are provided in module 22 located below board conveyance device 23. FIG. 3 is a block diagram illustrating a configuration of the multiplex communication system applied to component mounter 20. As illustrated in FIGS. 2 and 3, in component mounter 20 of the present example, data transmission between fixed section board 45 fixed in module 22 and the movable section (X-axis slide mechanism 27A and mounting head 25) moving in module 22 is performed with optical communication (multiplex communication) via optical fiber cables 81 and 82.

Device main body section 41 includes servo amplifier 83, device control main board 85, and image processing board 87. Device control main board 85 is a device that collectively controls the operation of component mounter 20. Device control main board 85 includes, for example, CPU, ROM, an HDD, RAM, and the like, is a device mainly configured with a computer, and controls board conveyance device 23, mounting head 25, head moving mechanism 27, and the like. Servo amplifier 83 is a device that controls power supplied to linear motor 77 of X-axis slide mechanism 27A and servo motor 75 of mounting head 25, which will be described later. Image processing board 87 is a board for inputting and processing image data of mark camera 69 of X-axis slide mechanism 27A and part camera 71 of mounting head 25, which will be described later.

Fixed section board 45 includes FPGA (Field Programmable Gate Array) 91, transmission-side photoelectric converters 93A and 94A, and reception-side photoelectric converters 93B and 94B. X-axis slide mechanism 27A includes X-axis board 95, mark camera 69, slave 61, linear motor 77, and linear scale 78. Mounting head 25 includes head board 97, part camera 71, slave 62, servo motor 75, and encoder 76.

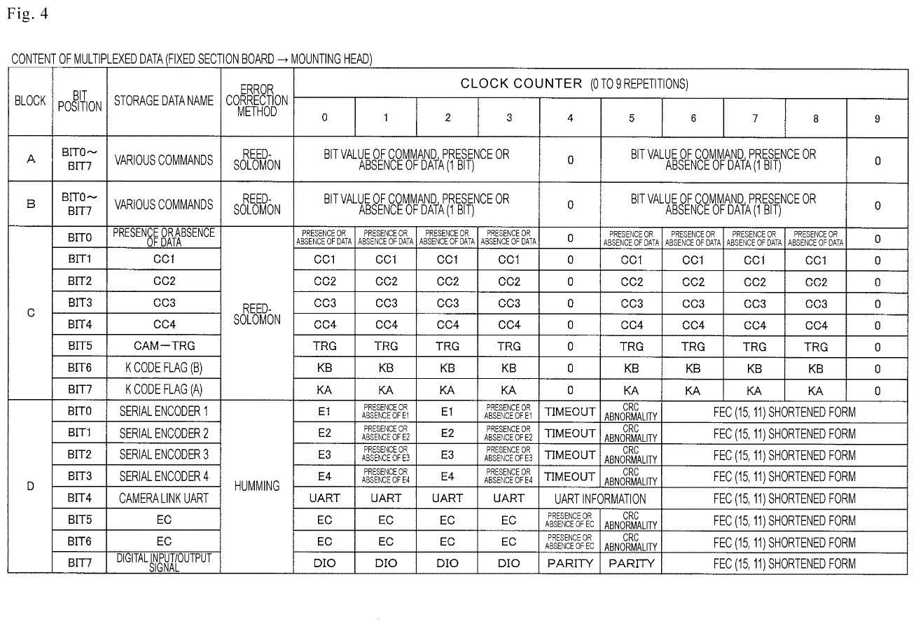

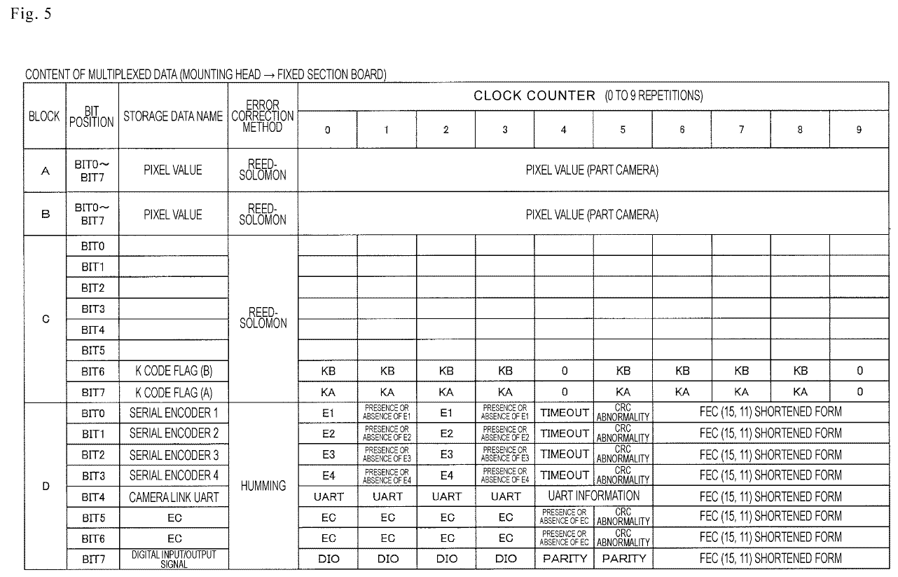

Component mounter 20 transmits and receives various types of data of devices provided in mounting head 25 and X-axis slide mechanism 27A through multiplex optical communication. The various types of data here are, for example, a linear scale signal of linear scale 78 provided in X-axis slide mechanism 27A and an encoder signal of encoder 76 provided in mounting head 25. The various types of data are, for example, image data of mark camera 69 and part camera 71. The various types of data are control data of slave 61 of X-axis slide mechanism 27A and slave 62 of mounting head 25. An example of data to be multiplexed will be described later with reference to FIGS. 4 and 5, but the present disclosure is not limited thereto.

FPGA 91 of fixed section board 45 multiplexes data input from servo amplifier 83, device control main board 85, and image processing board 87 of device main body section 41. For example, during activation, FPGA 91 reads configuration information from a nonvolatile memory (not illustrated) and constructs a logic circuit that performs multiplexing processing. FPGA 91 multiplexes the input data by, for example, time division multiplexing (TDM). For example, FPGA 91 multiplexes various types of data input from servo amplifier 83 or the like in accordance with a certain time (time slot) assigned to an input port, and transmits the multiplexed data that has been multiplexed to X-axis slide mechanism 27A or mounting head 25 via transmission-side photoelectric converters 93A and 94A.

X-axis board 95 of X-axis slide mechanism 27A includes transmission-side photoelectric converter 101A, reception-side photoelectric converter 101B, and FPGA 103. X-axis board 95 of X-axis slide mechanism 27A and head board 97 of mounting head 25 have the similar configuration to fixed section board 45. Therefore, in the description of X-axis board 95 and head board 97, description of the similar configuration to that of fixed section board 45 will be appropriately omitted. Transmission-side photoelectric converter 93A and reception-side photoelectric converter 93B of fixed section board 45 are connected to transmission-side photoelectric converter 101A and reception-side photoelectric converter 101B of X-axis slide mechanism 27A via optical fiber cable 81. FPGA 103 multiplexes image data of mark camera 69, a linear scale signal of linear scale 78, control data of slave 61, and the like.

Similarly, head board 97 of mounting head 25 includes transmission-side photoelectric converter 111A, reception-side photoelectric converter 111B, and FPGA 113. Transmission-side photoelectric converter 94A and reception-side photoelectric converter 94B of fixed section board 45 are connected to transmission-side photoelectric converter 111A and reception-side photoelectric converter 111B of mounting head 25 via optical fiber cable 82. FPGA 113 multiplexes image data of part camera 71 of mounting head 25, an encoder signal of encoder 76, control data of slave 62, and the like. The circuits (FPGAs 91, 103, and 113) that perform the multiplexing processing are not limited to an FPGA, and may be a programmable logic device (PLD) or a complex programmable logic device (CPLD). The multiplexing processing may be achieved with processing by an application specific integrated circuit (ASIC), software processing by CPU, or the like.

Optical fiber cables 81 and 82 have an improved bending resistance, for example, by adjusting arrangements and thicknesses of optical fiber lines in the cables. As a result, even in a case where optical fiber cables 81 and 82 are bent in association with movements of mounting head 25 or X-axis slide mechanism 27A, it is possible to transmit data stably without damaging the optical fiber lines. As illustrated in FIG. 1, for example, optical fiber cables 81 and 82 are attached to frame 22A of module 22 that supports a device cover or the like of component mounter 20, are disposed in a direction parallel to the Z-axis direction from fixed section board 45 in module 22, and are connected to mounting head 25 and X-axis slide mechanism 27A. Optical fiber cable 81 couples, for example, two optical fiber cables via repeater 81A attached to frame 22A, and connects fixed section board 45 and X-axis board 95 of X-axis slide mechanism 27A. Repeater 81A is attached to, for example, an intermediate position of frame 22A extending in the Z-axis direction, and has two connection ports. In repeater 81A, the optical fiber cable on an X-axis board 95 side is inserted into a first connection port, and the optical fiber cable on a fixed section board 45 side is inserted into a second connection port. Repeater 81A relays an optical signal between the two optical fiber cables.

Similarly, optical fiber cable 82 couples two optical fiber cables via repeater 82A attached to frame 22A, and connects fixed section board 45 and head board 97 of mounting head 25. In such a configuration, for example, in a case where a failure such as a crack temporarily occurs in a part of optical fiber cable 81, the optical fiber cable connected to X-axis board 95 or the optical fiber cable connected to fixed section board 45 can be exchanged among the two optical fiber cables relayed by repeater 81A. That is, it is not necessary to exchange all of the optical fiber cables from fixed section board 45 to the movable section (X-axis slide mechanism 27A or mounting head 25), and the failure can be recovered only by exchanging one of the two optical fiber cables relayed by repeaters 81A and 82A. Optical fiber cables 81 and 82 may be configured to connect fixed section board 45 and the movable section by one optical fiber cable without using repeaters 81A and 82A. The communication that connects fixed section board 45, mounting head 25, and X-axis slide mechanism 27A is not limited to wired communication, and may be optical wireless communication such as optical wireless communication path 53 (refer to FIG. 1) of loader 13.

Transmission-side photoelectric converter 93A of fixed section board 45 converts the multiplexed data multiplexed by FPGA 91 into an optical signal, and transmits the optical signal to reception-side photoelectric converter 101B of X-axis board 95 via optical fiber cable 81. Reception-side photoelectric converter 101B converts the optical signal received from transmission-side photoelectric converter 93A into a photocurrent of an electric signal and outputs the photocurrent to FPGA 103. FPGA 103 of the present example includes an AD conversion circuit and the like, and converts the analog photocurrent into a digital signal and processes the digital signal.

FPGA 103 demultiplexes the converted digital signal, that is, the multiplexed data, and separates data multiplexed in the multiplexed data. FPGA 103 outputs the separated various types of data to a corresponding device. Thus, the multiplex communication (optical communication) in which various types of data are multiplexed is executed between fixed section board 45 and X-axis slide mechanism 27A. Similarly, FPGA 103 multiplexes the image data and the like of mark camera 69 and transmits the multiplexed data to reception-side photoelectric converter 93B of fixed section board 45 via transmission-side photoelectric converter 101A. FPGA 91 demultiplexes the multiplexed data and outputs the separated various types of data to image processing board 87 of device main body section 41.

Similarly to X-axis slide mechanism 27A, fixed section board 45 also performs multiplex optical communication with mounting head 25. Transmission-side photoelectric converter 94A and reception-side photoelectric converter 94B of fixed section board 45 are respectively connected to transmission-side photoelectric converter 111A and reception-side photoelectric converter 111B of head board 97 via optical fiber cable 82. FPGA 91 of fixed section board 45 performs the multiplex communication with FPGA 113 of head board 97 via optical fiber cable 82. Multiplex communication lines of optical fiber cables 81 and 82 are, for example, full duplex communication of 5 Gbps.

Device main body section 41 of the present example controls X-axis slide mechanism 27A and mounting head 25 through the multiplex optical communication described above. Servo amplifier 83 of device main body section 41 executes initialization processing for linear scale 78 of X-axis slide mechanism 27A, acquisition processing of a linear scale signal, and the like. Linear scale 78 transmits a linear scale signal indicating a slide position of X-axis slide mechanism 27A to servo amplifier 83 via the multiplex communication. Servo amplifier 83 is connected to linear motor 77 of X-axis slide mechanism 27A via a power supply line (not illustrated), and executes feedback control on linear motor 77 by changing power supplied to linear motor 77 based on a linear scale signal of linear scale 78. Device control main board 85 controls servo amplifier 83 based on the production program or the like received from host computer 15. Accordingly, X-axis slide mechanism 27A moves to a position in the X-axis direction based on the production program.

Similarly, servo amplifier 83 executes initialization processing for encoder 76 of mounting head 25, acquisition processing for an encoder signal, and the like. Encoder 76 transmits an encoder signal indicating a rotational position of servo motor 75 and the like to servo amplifier 83 via the multiplex communication. As described above, servo motor 75 functions as a drive source or the like for driving the holding member provided in mounting head 25. Servo amplifier 83 is connected to encoder 76 of mounting head 25 via a power supply line (not illustrated), and executes feedback control on servo motor 75 based on an encoder signal of encoder 76. Accordingly, mounting head 25 rotates the holding member or moves the holding member up and down based on the production program.

Device control main board 85 of device main body section 41 can control the relays, sensors, and the like provided in X-axis slide mechanism 27A and mounting head 25 via the industrial network described above. Device control main board 85 functions as a master in the industrial network, and transmits control data to slave 61 of X-axis slide mechanism 27A and slave 62 of mounting head 25 via the multiplex communication. Slaves 61 and 62 drive the relays and sensors of X-axis slide mechanism 27A and mounting head 25 based on the control data received from device control main board 85. Slaves 61 and 62 write values of signals acquired from the relays and sensors into the control data, and transmit the control data to device control main board 85 via the multiplex communication. Accordingly, device control main board 85 can control the relay and the like of each device.

A configuration of the multiplex communication system illustrated in FIG. 3 is an example, and can be appropriately changed. For example, a linear scale signal attached to a linear motor (not illustrated) of Y-axis slide mechanism 27B (refer to FIG. 2) may be transmitted through the multiplex communication. In addition, a signal of the relay or the like of Y-axis slide mechanism 27B may be transmitted through the multiplex communication. Fixed section board 45 may include a slave controlled by device control main board 85. Slave 61 may be a circuit block (such as an IP core) of FPGA 103, that is, a part of FPGA 103. Further, component mounter 20 need not include devices (a circuit functioning as a master of device control main board 85, slaves 61 and 62, and the like) related to the industrial network.

With the configuration described above, device control main board 85 controls component mounter 20 based on the production program received from host computer 15. Device control main board 85 receives data collected by the industrial network, a linear scale signal of linear scale 78, an encoder signal of encoder 76, and the like via the multiplex communication. Further, device control main board 85 inputs a result (error of the holding position or the like) of processing the image data captured by mark camera 69 or part camera 71 with image processing board 87. Device control main board 85 determines the following control content (a type, a mounting position, and the like of the electronic component to be mounted) based on these data and the like. Device control main board 85 controls various devices according to the determined control content.

### (Configuration of Multiplexed Data)

Next, content of multiplexed data transmitted through the multiplex communication described above will be described. FIG. 4 illustrates the content of multiplexed data transmitted from fixed section board 45 to mounting head 25 in the multiplex communication of optical fiber cable 82. FIG. 5 illustrates the content of multiplexed data transmitted from mounting head 25 to fixed section board 45 in optical fiber cable 82. Data arrays and the content of the data in FIGS. 4 and 5 are examples. Since a similar configuration as the multiplexed data of optical fiber cable 82 (a configuration in which part camera 71 and mark camera 69 are replaced with each other, a configuration in which encoder 76 and linear scale 78 are replaced with each other, or the like) can be adopted for the multiplexed data transmitted through optical fiber cable 81 connecting fixed section board 45 and X-axis slide mechanism 27A, the description thereof will be omitted.

Each of FIGS. 4 and 5 illustrates the multiplexed data of 32 bits (blocks A to D, each of which is 8 bits). For example, in order to maintain a DC balance of the transmitted data, the multiplexed data is subjected to 8B/10B conversion every 8 bits (each block), and the total of 40 bits are obtained. Therefore, in the multiplexed data, for example, one frame is configured with 40 bits. For example, when a cycle per frame is set to 8 nsec (a frequency is 125 MHZ), FPGAs 91 and 113 construct a multiplexed communication line of 5 Gbps (40 bits×125 MHz).

FIGS. 4 and 5 illustrate multiplexed data for each clock (for example, 8 nsec). FIGS. 4 and 5 illustrate data of 10 clocks from 0 to 9. A first block A (BIT (bit) 0 to BIT 7) of the multiplexed data transmitted from fixed section board 45 illustrated in FIG. 4 is used for transmitting a control command or the like to mounting head 25, for example. This command is, for example, a symbol or the like for controlling a K code in the 8B/10B conversion. The similar data to block A is set in a block B of the multiplexed data illustrated in FIG. 4. As an error correction method of blocks A and B, for example, a Reed-Solomon code can be used. For example, when receiving the multiplexed data, FPGAs 91 and 113 execute error detection and error correction on the data of block A whose multiplexing has been released based on the Reed-Solomon code. A 1-bit value indicating the presence or absence of data is set in blocks A and B. The bit value indicating the presence or absence of data is a value indicating whether valid data is set in blocks A and B when a communication speed between devices that input and output data transmitted in blocks A and B is slow with respect to a communication speed (5 Gbps) of the multiplex communication. Accordingly, a reception-side device that receives the data of blocks A and B can detect whether valid data is set based on the bit value indicating the presence or absence of the data, and can quickly perform data processing and data discarding.

A pixel value (image data) of part camera 71 is set in blocks A and B of the multiplexed data transmitted from mounting head 25 illustrated in FIG. 5. As an error correction method, for example, a Reed-Solomon code can be used. When mounting head 25 includes multiple cameras, blocks A and B may be separately used to transmit image data of the respective cameras.

In addition, a control signal or the like for controlling part camera 71 is set in the multiplexed data block C (BIT 1 to BIT 5) illustrated in FIG. 4. The control signal here is, for example, control signals CC1 to CC4 in the case of the Camera Link standard. Alternatively, the control signal is a trigger signal (CAM-TRG in the drawing) or the like for instructing part camera 71 to capture an image. A bit value indicating the presence or absence of the data in block C is set to BIT 0 in block C.

In addition, in BIT 6 of block C, a parity bit (K code flag in the drawing) for detecting whether a burst error or the like exceeding a correction capability has occurred in encoding by the Reed-Solomon code for block B. Specifically, for example, in setting of the encoding by the Reed-Solomon code, the setting is made such that continuous errors of two blocks can be continuously corrected. In this case, if continuous errors of three or more blocks occur in the multiplex communication, the reception side (mounting head 25) cannot correct data. For example, when even-number parity corresponding to 8 bits of block B is set in BIT 6 of block C. and a continuous error of three or more blocks is detected on the reception side, abnormal stop, correction of image data (when fixed section board 45 of FIG. 5 is the reception side), and the like are executed. Similar to BIT 6, the parity bit corresponding to block A is set in BIT 7 of block C. In block C of the multiplexed data illustrated in FIG. 5, the parity bit (K code flag in the drawing) is set in BIT 6 and BIT 7 as in FIG. 4. Blank portions (BIT 0 to BIT 5 of block C) illustrated in FIG. 5 indicate empty bits in which data has not been set.

Further, an encoder signal of encoder 76 of mounting head 25 is set in BIT 0 to BIT 3 of block D of FIGS. 4 and 5. In the case of FIG. 4, the encoder signal here is an initial setting signal to be transmitted from servo amplifier 83 to encoder 76, a signal for inquiring a state, a signal for acquiring position information, or the like. In the case of FIG. 5, the encoder signal is a signal indicating position information or the like transmitted from encoder 76 to servo amplifier 83. For example, mounting head 25 includes four sets of servo motors 75 and encoders 76. In this case, mounting head 25 can move the holding member in movement directions of four axes. In FIGS. 4 and 5, BIT 0 to BIT 3, four in total, are set corresponding to four-axis encoders 76, respectively. As an error correction method for the data of block D, for example, a Humming code can be used.

In BIT 0 of block D, the data of the encoder signal is set to first four clocks (clocks 0 to 3 in FIGS. 4 and 5) of the ten clocks (E1 in FIGS. 4 and 5). Bit allocation of an encoder signal is performed to each bit position in clocks 0 and 2. Bit allocation of Information indicating presence or absence of the data of the encoder signal (“presence or absence of E1” in FIGS. 4 and 5) is performed to each bit position in the clocks 1 and 3. As described above, the information indicating the presence or absence of the data is information for indicating whether a low-speed encoder signal is set at each bit position (clocks 0 and 1 of BIT 0) when a data transfer rate of the encoder signal is lower than a data transfer rate of the multiplexed data, for example. The encoder signal and the information indicating the presence or absence of the encoder signal are alternately set for each cycle.

In the clock 4 of BIT 0, timeout information indicating whether a timeout error has occurred in communication between servo amplifier 83 and encoder 76 is set. In clock 5 of BIT 0, a bit value for cyclic redundancy check (CRC) is set by the transmission side (“CRC abnormality” in FIGS. 4 and 5). A 4-bit code bit that is a Humming code of a forward error correction code is set in the clocks 6 to 9 of BIT 0. The error correction code is, for example, a shortened form of the Humming code (15, 11). Similarly to BIT 0, a 4-bit code bit is set in the clocks 6 to 9 of BIT 1 to 7. When receiving the multiplexed data, FPGAs 91 and 113 execute error detection and error correction on the data such as the encoder signal whose multiplexing has been released based on the error correction code. In BIT 1 to BIT 3, data related to the encoder signal is set similarly to BIT 0.

A control signal of part camera 71 is set in BIT 4 of block D illustrated in FIGS. 4 and 5. The control signal here is, for example, a control signal of UART communication for controlling turning on of lighting or the like of part camera 71, when part camera 71 is a camera of the Camera Link standard. Information related to data values of clocks 0 to 3 is set in clocks 4 and 5 of BIT 4.

In BIT 5 and BIT 6 of block D illustrated in FIGS. 4 and 5, data related to the industrial network, for example, EtherCAT (registered trademark) is set (“EC” and the like in FIGS. 4 and 5). This data is control data of slave 62. Control data of EtherCAT (registered trademark) is set in 4 bits of clocks 0 to 3 of BIT 5 and BIT 6. Information indicating the presence or absence of the data is set in the clock 4 of BIT 5 and BIT 6. In the clock 5 of BIT 5, a bit value for cyclic redundancy check (CRC) is set by the transmission side.

Data related to a digital input/output signal (DIO signal) is set in BIT 7 of block D illustrated in FIGS. 4 and 5. The DIO signal is a signal for driving various relays, sensors, and the like attached to module 22 and mounting head 25, and a signal output from the relays, sensors, and the like. For example, device main body section 41 drives the various relays and sensors using the DIO signal, and acquires the signal from the relays and sensors. A bit value indicating content of the DIO signal is set to the four bits of clocks 0 to 3 of BIT 7. A parity code of the DIO signal is set in two bits of clocks 4 and 5 of BIT 7. For example, in the error detection processing of the DIO signal, in addition to the error correction using the Humming code, multiple-times match check using the parity codes of the clocks 4 and 5 is executed. Specifically, after checking that all the data has the same data value in a predetermined number of continuous transmissions, the transmitted data is acquired. When there is a case where the data value is different even once in the continuous transmission, the data transmission is cancelled. Error detection/correction processing of the DIO signal may be performed with only one of the Humming code and the parity code.

The bit position of data, the error detection/correction method, the type of data, and the like illustrated in FIGS. 4 and 5 are examples. For example, a signal of a board height sensor attached to X-axis slide mechanism 27A may be transmitted through multiplex communication to detect an error of data. The board height sensor here is, for example, a sensor that measures a height of an upper surface of board 17 based on a reference height position set in component mounter 20. For example, device main body section 41 may acquire the signal of the board height sensor using data of a bit position of a predetermined block of the multiplex communication. In this case, for example, a Humming code can be used as an error detection/correction code of the signal of the board height sensor.

### (Error Detection/Correction in Multiplex Communication)

Next, error detection/correction processing of data performed by component mounter 20 of the present example in the multiplex communication system described above will be described. Each of FPGAs 91, 103, and 113 separates various types of data from the multiplexed data received in the multiplex communication, and executes error detection/correction processing on the separated data using the Reed-Solomon code or the Humming code described above. Each of FPGAs 91, 103, and 113 announce to device control main board 85 of device main body section 41 that the correction has been executed, while recording the number of times of executed error correction as a log. FPGAs 103 and 113 announce the execution of the correction to device control main board 85 via the multiplex communication of optical fiber cables 81 and 82 and FPGA 91 while recording the number of times of error correction. For example, FPGAs 103 and 113 announce the execution of the correction by using the empty bits (BIT 0 to BIT 5) of block C of FIG. 5. When the number of times of correction announced from FPGAs 91, 103, and 113 becomes equal to or greater than a predetermined threshold number within a predetermined time, device control main board 85 makes notification of notification information related to the communication abnormality. For example, device control main board 85 displays the notification information on touch panel 29A of operation section 29. Error detection/correction processing by FPGAs 103 and 113 is similar to that of FPGA 91. Therefore, in the following description, the error detection/correction processing of FPGA 91 will be mainly described, and the description of the processing of FPGAs 103 and 113 will be appropriately omitted. In addition, a case where FPGA 91 detects and corrects an error in the multiplexed data received from mounting head 25 (FPGA 113) will be mainly described. In addition, FPGAs 91, 103, and 113 execute multiple-times match check using the parity codes on the digital input/output signal of BIT 7 of block D illustrated in FIGS. 4 and 5. Similarly to the number of times of error correction described above, FPGAs 91, 103, and 113 may announce to device control main board 85 that an error is detected, while recording the number of times of error detection by the multiple-times match check. Then, when the number of times of error detection announced from FPGAs 91, 103, and 113 becomes equal to or greater than a predetermined threshold number within a predetermined time, device control main board 85 may make notification of notification information related to the communication abnormality.

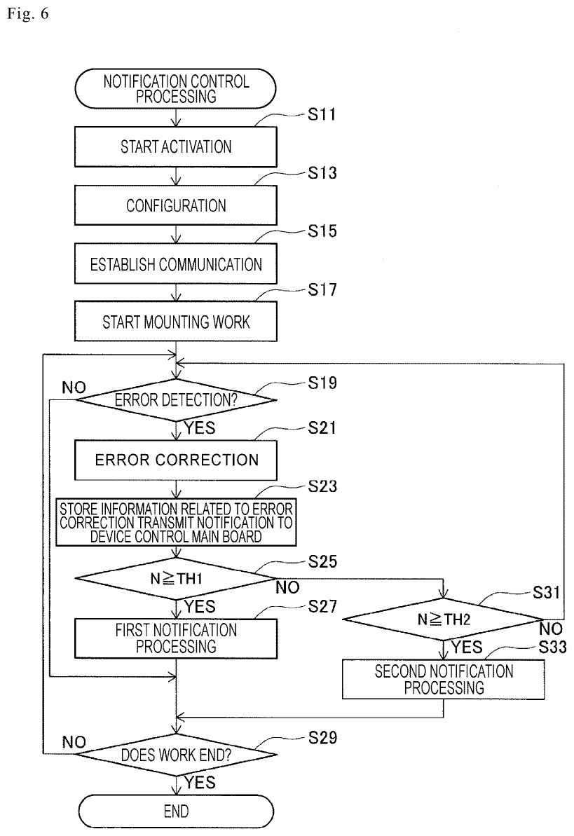

FIG. 6 illustrates notification control processing executed by component mounter 20. First, in step (hereinafter, simply referred to as S) 11 of FIG. 6, when the power is turned on by the user, device main body section 41 of component mounter 20 starts the activation of the system. Device main body section 41 supplies power to each device of component mounter 20 by controlling a power supply device (not illustrated). When supplied with power and activated, FPGA 91 reads configuration information from a nonvolatile memory (not illustrated) and constructs a logic circuit that performs multiplexing processing (S13). The logic circuit includes, in addition to a logic circuit for multiplexing data, a logic circuit for separating the received multiplexed data, a logic circuit for executing error detection/correction on various types of separated data (refer to FIGS. 4 and 5), and a logic circuit for recording the number of times of executed error correction.

After constructing the logic circuit, FPGA 91 establishes the multiplex communication with FPGAs 103 and 113 (S15). When the establishment of the communication is successful, FPGA 91 transmits, to device main body section 41, a notification that the establishment of communication is completed. When the establishment of the multiplex communication and preparation of various devices are completed, device control main board 85 of device main body section 41 starts mounting work of electronic components (S17). For example, device control main board 85 acquires the production program from host computer 15, and starts the mounting work when acquiring a work start instruction.

On the other hand, when FPGA 91, FPGA 103, and FPGA 113 establish the multiplex communication in S15, FPGA 91, FPGA 103, and FPGA 113 perform error detection processing on the multiplexed data received in the multiplex communication (S19). FPGAs 91, 103, and 113 perform error detection processing using the Reed-Solomon code or the Humming code. The timing at which FPGAs 91, 103, and 113 start the error detection processing is not limited to the timing at which the mounting work is started, and may be the timing at which the multiplex communication is established.

For example, FPGA 91 determines whether an error is detected in the multiplexed data received from head board 97 (FPGA 113) during the mounting work (S19). When an error is not detected in FPGAs 91, 103, and 113 (S19: NO), for example, when it is not announced from any of FPGAs 91, 103, and 113 that an error is detected for a certain period of time, device main body section 41 determines whether the mounting work is ended, with device control main board 85 (S29). When device control main board 85 determines that the work based on the production program has not been completed (S29: NO), device main body section 41 causes FPGA 91, 103, or 113 to perform the determination processing of S19 again. Accordingly, device main body section 41 causes FPGAs 91, 103, and 113 to execute data error detection (S19), and causes device control main board 85 to determine whether the mounting work is ended (S29). When device control main board 85 determines that the mounting work is ended (S29: YES), device main body section 41 ends the processing illustrated in FIG. 6. For example, when device main body section 41 acquires a start instruction for the next mounting work from host computer 15, device main body section 41 executes the processing from S17.

In S19, for example, FPGA 91 detects an error of data for each unit of data to which a predetermined symbol number in a Reed-Solomon code or a Humming code is added, and when an error is detected, FPGA 91 makes a positive determination in S19 (S19: YES). When an error is detected (S19: YES), FPGA 91 executes processing of correcting the detected error (S21). When the error is corrected, FPGA 91 stores information related to the error correction as a log in a memory or the like of FPGA 91 (S23). FPGA 91 stores, for example, information such as a time when the error is corrected and a type of corrected data. FPGA 91 transmits, to device control main board 85, a notification that the error correction has been executed (S23). FPGA 91 announces, for example, a communication path (optical fiber cables 81 and 82) on which the error correction has been performed, a type of data on which the correction has been performed (a block name, a bit position (in a case of the Humming code), a data name, a type of an error correction code, and the like), information on a time when the correction has been performed, and the like to device control main board 85. Similarly to FPGA 91, FPGAs 103 and 113 execute the error detection/correction of data in the received multiplexed data, the recording of a log, and the announcement to device control main board 85.

For example, when the announcement of S23 from FPGA 91 is acquired, device control main board 85 determines whether number N of times of correction by which FPGA 91 has executed the error correction within a predetermined time is equal to or greater than first threshold number TH1 (S25). The predetermined time in S25 is, for example, one hour. First threshold number TH1 is, for example, 20 times. For example, as illustrated in FIG. 5, FPGA 91 executes error detection/correction for each of blocks A, B, and C using the Reed-Solomon code and error detection/correction for each bit position of block D using the Humming code. FPGA 91 executes error detection/correction for each block or each bit position (hereinafter, collectively referred to as “for each block or the like”), and announces the number of times of correction for each block or the like. Device control main board 85 stores, for example, the announcement from FPGA 91 as a history, and when a new announcement is acquired, device control main board 85 acquires the number of times of receiving an announcement within the past one hour from the history. Device control main board 85 determines number N of times of correction individually for each block or the like, and when the error correction is executed 20 times or more for at least one block (at least one bit position in the case of block C) among four blocks A to D within one hour, a positive determination is made in S25 (S25: YES), and S27 is executed. When number N of times of error correction within one hour is less than 20 for all of the four blocks (all bit positions in the case of block C), device control main board 85 makes a negative determination in S25 (S25: NO) and executes S31. Device control main board 85 may determine number N of times of correction for each line without determining number N of times of correction for each block or the like. For example, device control main board 85 may make a positive determination in S25 when a sum of number N of times of correction of blocks A to D that occurs within one hour is equal to or greater than first threshold number TH1 in the multiplexed data received from mounting head 25.

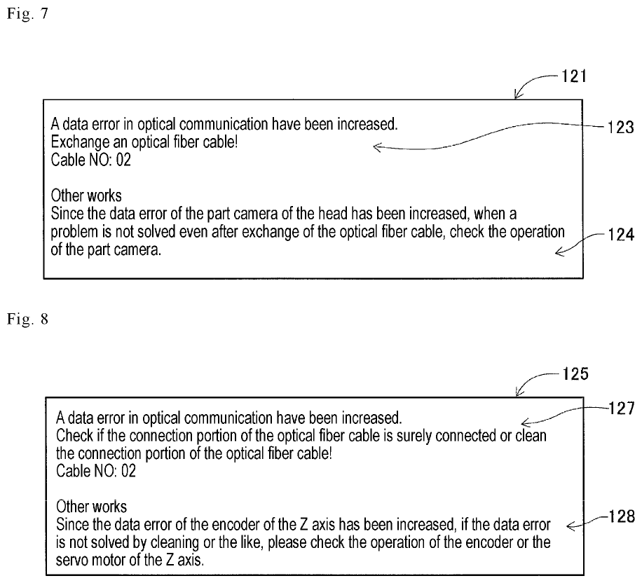

In S27, device control main board 85 executes first notification processing, and displays notification information instructing exchanging of optical fiber cable 82 on touch panel 29A. FIG. 7 illustrates an example of display screen 121 displayed on touch panel 29A in the first notification processing of S27. As illustrated in FIG. 7, device control main board 85 displays, for example, exchange message 123 and work instruction message 124 on display screen 121. Device control main board 85 displays, as exchange message 123, text indicating that the data error has increased and text for prompting the user to exchange optical fiber cable 82. Here, when the number of errors of data is significantly increased, there is a high possibility of a case such as a crack of optical fiber cable 82 where it is difficult to maintain the communication quality. On the other hand, when the number of errors of data slightly increased, it is considered that a connection portion of optical fiber cable 82 is not appropriately connected, or the user has touched the connection portion during exchanging and the connection portion is contaminated. That is, there is a possibility that occurrence of an error of data can be suppressed by cleaning or the like without replacing optical fiber cable 82. When the number of occurrence of correction is equal to or more than first threshold number TH1, which is larger than second threshold number TH2 described later, within a predetermined time, device control main board 85 displays exchange message 123 for prompting the exchanging of optical fiber cable 82. Accordingly, it is possible to cause the user to quickly exchange optical fiber cable 82, shorten a downtime in which the mounting work of component mounter 20 is stopped, and improve the productivity. Therefore, first threshold number TH1 used in S25 is a value with which the number of occurrence of data errors (number N of times of correction) increased because of a factor such as a crack of optical fiber cable 82 that requires exchange of optical fiber cable 82 is detectable.

Further, device control main board 85 displays information indicating which optical fiber cable from among optical fiber cable 81 or 82 is an exchange target in exchange message 123. For example, in device control main board 85, numbers NO: 01 and 02 are set for optical fiber cables 81 and 82, respectively. Further, the numbers are also attached to coatings of the actual optical fiber cables. Then, device control main board 85 displays the number corresponding to optical fiber cables 81 or 82 for which number N of times of correction is increased in S27 as cable NO in exchange message 123. Accordingly, the user can easily determine the optical fiber cable that is an exchange target by viewing displayed cable NO.

In addition, device control main board 85 displays, as work instruction message 124, notification information for prompting execution of maintenance for the device that has processed, on the transmission side, the data with increased number N of times of error correction. Device control main board 85 can specify data for which number N of times of correction has been increased and a device that processes the data on the transmission side based on the information (block name, bit position, and the like) announced from FPGA 91. FIG. 7 illustrates, as an example, work instruction message 124 when number N of times of correction of the image data (refer to blocks A and B in FIG. 5) of part camera 71 is increased. As illustrated in FIG. 7, device control main board 85 displays, as work instruction message 124, a message indicating that the data error of part camera 71 has increased and a message for prompting to check the operation of part camera 71.

Accordingly, device control main board 85 displays the notification information for prompting execution of maintenance for the device (for example, part camera 71) that has processed, on the transmission side, the data with increased number N of times of correction by which the errors have been corrected among the multiple pieces of multiplexed data. Accordingly, the user can perform check focusing on a maintenance item related to part camera 71, such as experimental imaging of part camera 71 and reconstruction of a logic circuit for processing image data of part camera 71. A cause of occurrence of a data error can be more quickly identified and solved.

After executing S27, device control main board 85 determines whether to end the mounting work (S29). When device control main board 85 determines that the mounting work has not been ended (S29: NO), device main body section 41 causes FPGA 91, FPGA 103, or FPGA 113 to perform the determination processing of S19. When device control main board 85 determines that the mounting work has been ended (S29: YES), device main body section 41 ends the processing illustrated in FIG. 6. Device control main board 85 may stop the mounting work according to an occurrence state of an error in the multiplexed data. For example, device control main board 85 may stop the mounting work in a case where the number of times of correction by which the error correction has been executed within a predetermined time exceeds an upper limit value. This makes it possible to quickly stop the mounting work, for example, when optical fiber cables 81 and 82 are completely disconnected.

On the other hand, in S31, device control main board 85 determines whether number N of times of correction by which FPGA 91 has executed the error correction within the predetermined time is equal to or greater than second threshold number TH2. The predetermined time in S31 is, for example, one hour. Second threshold number TH2 is, for example, 10 times. Therefore, second threshold number TH2 is a number smaller than first threshold number TH1 described above. More specifically, second threshold number TH2 is, for example, a value with which number N of times of correction caused by contamination or the like of the connection portion of optical fiber cable 81 is detectable, and is a value with which occurrence of a data error in a situation in which exchange of optical fiber cable 82 is not required is detectable.

When the error correction has been executed ten times or more within one hour for at least one block (at least one bit position in the case of block C) among four blocks A to D, device control main board 85 makes a positive determination in S31 (S31: YES) and executes S33. When number N of times of error correction within one hour is less than ten for all of the four blocks, device control main board 85 makes a negative determination in S31 (S31: NO) and executes S19 again. Therefore, when number N of times of correction is less than second threshold number TH2, component mounter 20 continues the mounting work without executing notification processing.

In S33, device control main board 85 executes the second notification processing, and displays cleaning message 127 and work instruction message 128 on display screen 125 of touch panel 29A as illustrated in FIG. 8. As illustrated in FIG. 8, device control main board 85 displays, as cleaning message 127, a message indicating that the data error has increased, a message for prompting cleaning of the connection portion of optical fiber cable 82, and cable NO. Accordingly, it is possible to prompt the user to perform check for connection or cleaning on the connection portion of optical fiber cable 82, for example, the connection portion between optical fiber cable 82 and mounting head 25 or the connection portion of repeater 82A. Similarly to S27, device control main board 85 displays work instruction message 128 for prompting execution of maintenance for the device that has processed, on the transmission side, the data with increased number N of times of correction. FIG. 8 illustrates, as an example, work instruction message 128 when number N of times of correction of the encoder data of encoder 76 (BIT 1 to BIT 4 of block D in FIG. 5) is increased. Device control main board 85 determines number N of times of correction for each of the four encoder data (BIT 1 to BIT 4 of block D in FIG. 5), and displays information with which encoder 76 with increased number N of times of correction can be specified, in work instruction message 128. Device control main board 85 displays, for example, information (Z axis in the illustrated example) of a rotation axis of servo motor 75 to which encoder 76 is attached, in work instruction message 128. Device control main board 85 displays, as work instruction message 128, a message indicating that the data error of encoder 76 of the Z axis has increased and a message for prompting to check the operation of encoder 76 and servo motor 75. After executing S33, device control main board 85 determines whether to end the mounting work (S29).

Device control main board 85 may prompt the user to perform exchange of optical fiber cable 82 or the like when a certain number of occurrence of data errors continues. For example, when number N of times of correction equal to or less than second threshold number TH2 or number N of times of correction less than first threshold number TH1 and equal to or greater than second threshold number TH2 continues for a certain period of time, device control main board 85 may display a message indicating exchange of optical fiber cable 82 or the like on touch panel 29A.

In the above description, the multiplexed data received by FPGA 91 via optical fiber cable 82 is mainly described, but the number of times of correction of the data can be similarly monitored and notification of the notification information can be made for the multiplexed data received by FPGA 91 via optical fiber cable 81 or the multiplexed data received by FPGAs 103 and 113. For example, FPGA 113 of mounting head 25 detects and corrects an error of data in the multiplexed data (refer to FIG. 4) received from fixed section board 45 in the similar manner to FPGA 91 described above. FPGA 113 detects an error of data for each block or the like of the multiplexed data illustrated in FIG. 4 and transmits a notification to device control main board 85.

As described above, device control main board 85 determines whether number N of times of correction occurring within a predetermined time (for example, one hour) in FPGA 91 is equal to or greater than first threshold number TH1 or second threshold number TH2 (S25, S31), thereby determining an increase in the number of times of data error detection. In such a configuration, an increase in a data error can be detected using first threshold number TH1 and second threshold number TH2. Further, by adjusting a value of first threshold number TH1 or the like, the notification can be executed at a desired timing.

When the number N of times of correction is equal to or greater than first threshold number TH1 (S25: YES), device control main board 85 displays an exchange instruction for optical fiber cable 81 (refer to FIG. 7). When the number N of times of correction is equal to or greater than second threshold number TH2, which is less than first threshold number TH1 (S31: YES), device control main board 85 displays a cleaning instruction for the connection portion of optical fiber cable 81 (refer to FIG. 8). Accordingly, it is possible to instruct the user in accordance with an amount of increase in number N of times of correction, and it is possible to cause the user to take more appropriate measures. For example, when the cleaning of optical fiber cable 82 is sufficient, the mounting work can be resumed without performing an unnecessary work such as exchange of optical fiber cable 82.

In addition, FPGA 91 performs error correction based on an error correction code such as the Reed-Solomon code or the Humming code on each of the multiple pieces of data separated from the received multiplexed data (S21). Device control main board 85 determines an increase in number N of times of correction using the number of times an error of at least one piece of data among multiple pieces of data (data for each of blocks A to C and data at each bit position of block D) multiplexed in the multiplexed data is corrected as number N of times of correction (S25, S31). According to this, when optical fiber cable 82 is broken or disconnected and the number of errors occurring in any data of the multiplexed data is increased, occurrence of a failure can be detected more quickly by monitoring each data.

FPGA 91 detects and corrects an error of data in the multiplexed data received via each of optical fiber cables 81 and 82. Device control main board 85 individually determines an increase in number N of times of correction for each of optical fiber cables 81 and 82, and performs notification. According to this, it is possible to individually monitor number N of times of error correction for each of two optical fiber cables 81 and 82 connected to one optical receiving device. In particular, in optical fiber cables 81 and 82 connected to a movable device such as X-axis slide mechanism 27A or mounting head 25 of the present example, there is a high possibility that a signal line is broken or disconnected. Therefore, it is extremely effective to individually monitor a data error in optical fiber cables 81 and 82 to which such a movable device is connected.

Board 17 in the above example is an example of a workpiece of the present disclosure. Mounting head 25 is an example of a head. X-axis slide mechanism 27A is an example of a first moving device. Y-axis slide mechanism 27B is an example of a second moving device. Component mounter 20, device main body section 41, and fixed section board 45 are examples of an optical communication device. Optical fiber cables 81 and 82 are examples of a wired cable. Optical fiber cable 81 is an example of a second wired cable. Optical fiber cable 82 is an example of a first wired cable. FPGAs 91, 103, and 113 are examples of a detection device. Device control main board 85 is an example of a determination device. Transmission-side photoelectric converters 93A, 94A, 101A, and 111A and light emitting elements 51A and 52A are examples of an optical transmission device. Transmission-side photoelectric converter 101A is an example of a first moving device-side optical transmission device. Transmission-side photoelectric converter 111A is an example of a head-side optical transmission device. Reception-side photoelectric converters 93B, 94B, 101B, and 111B and light receiving elements 51B and 52B are examples of an optical receiving device. Exchange message 123, work instruction messages 124 and 128, and cleaning message 127 are examples of notification information. The multiplexed data is an example of received data. The X-axis direction is an example of a first direction. The Y-axis direction is an example of a second direction. S19 is an example of a detection step. S25, S27, S31, and S33 are an example of a notification step.

As described above, according to the present example described above, the following advantageous effects can be achieved.

In an aspect of the present example, FPGA 91 detects an error of data in the multiplexed data received by reception-side photoelectric converter 94B (S19), and corrects the error of data (S21). Device control main board 85 determines an increase in number N of times of error correction of FPGA 91 (S25, S31), and makes notification of the notification information related to the communication abnormality based on the determination that number N of times of correction has been increased (S27, S33). According to this, when quality of the communication is degraded because of deterioration of an optical communication light emitting element issuing element or optical fiber cables 81 and 82 and the error of data is increased, it is possible to notify the user of the occurrence of a communication failure or a possibility of the occurrence of a communication failure by the notification information.

The present disclosure is not limited to the above example, and it is needless to say that various improvements and changes can be made without departing from the gist of the present disclosure.

For example, the optical communication device that performs optical communication of the present disclosure may be configured such that both devices on the transmission side and the reception side are movable, or may be configured such that both devices are fixed.

The detection device of the present disclosure need not be a programmable logic device such as FPGA 91. For example, processing of detecting an error of data may be achieved by hardware processing such as ASCI, or may be achieved by software processing by executing a program by CPU.

Content, an order of processing, a subject of processing, and the like of the flowchart illustrated in FIG. 6 are examples. For example, in the above example, device control main board 85 executes the determination processing using first threshold number TH1 in S25 and the determination processing using second threshold number TH2 in S31, but FPGA 91 may execute the determination processing. Further, device control main board 85 may execute the data error detection processing in S19.

In the example described above, FPGAs 91, 103, and 113 correct errors, but may execute only detection. For example, FPGA 91 may execute only detection of an error in the multiplexed data received from mounting head 25 and notify device control main board 85 of the error. Specifically, FPGA 91 performs the multiple-times match check using the parity code on the digital input/output signal illustrated in FIGS. 4 and 5, and announces to device control main board 85 that an error is detected. Then, device control main board 85 may make notification of the notification information related to the communication abnormality when the number of times of error detection announced from FPGA 91 becomes equal to or greater than a predetermined threshold number within a predetermined time. Accordingly, not only the Reed-Solomon code or the Humming code but also the parity code or the like that can detect an error and does not have a correction function may be used.

Although device control main board 85 make notification of the notification information when number N of times of correction of at least one piece of data among the multiple pieces of data multiplexed in the multiplexed data is increased, device control main board 85 may perform the notification only when numbers N of times of correction of all pieces of data (blocks A to D) are increased.

In the above example, multiplex communication using optical fiber cables 81 and 82 is described as an example of the optical communication of the present disclosure, but the present disclosure is not limited thereto. The optical communication may be optical wireless communication between optical signal transceiver 51 and optical signal transceiver 52 illustrated in FIG. 1. In this case, for example, optical signal transceiver 51 may execute error detection/correction of data in the data (position information or error information) of the optical wireless communication received from optical signal transceiver 52. The optical communication of the present disclosure may be communication in which multiplexing is not performed.

In the above example, device control main board 85 detects an increase in the data error by comparing number N of times of correction of the data error occurring within a predetermined time with the thresholds (first threshold number TH1 and second threshold number TH2), but a method of detecting an increase in the data error is not limited thereto. For example, device control main board 85 may compare a time interval at which the data error is corrected with a threshold, and make notification of the notification information when the time interval becomes equal to or less than a predetermined threshold.

In the above example, a notification method using text is adopted as a notification method of the notification information, but the present disclosure is not limited thereto. For example, occurrence of a data error or cleaning of optical fiber cable 82 may be notified to the user by audio.

Further, device control main board 85 may execute notification to a device outside component mounter 20, for example, host computer 15.

The first direction of the present disclosure may be the Y-axis direction.

In the above example, component mounter 20 that mounts the electronic component on board 17 is adopted as the operating machine of the present disclosure, but the present disclosure is not limited thereto. For example, a solder application device that applies solder to board 17 can be adopted as the operating machine. In this case, a device that holds a squeegee for applying solder to a board is an example of the head of the present disclosure. Further, as the operating machine, a board inspection device, which inspects the board after the electronic component is mounted by component mounter 20, solder is applied by the application device, and the solder is melted and fired in a reflow oven, may be adopted. In this case, a camera head for inspecting the board is an example of the head of the present disclosure. Alternatively, the operating machine may be a machine tool that executes a machining work on a target object other than the board, for example, a workpiece. In this case, a head of a robot (loader) that grips a workpiece and moves in the Z-axis direction or the X-axis direction is an example of the head of the present disclosure.

### REFERENCE SIGNS LIST

17 board (workpiece), 20 component mounter (operating machine, optical communication device), 25 mounting head (head), 27A X-axis slide mechanism (first moving device), 27B Y-axis slide mechanism (second moving device), 41 device main body section (optical communication device), 45 fixed section board (optical communication device), 85 device control main board (determination device), 91, 103, 113 FPGA (detection device), 81 optical fiber cable (wired cable, second wired cable), 82 optical fiber cable (wired cable, first wired cable), 93A, 94A, 101A, 111A transmission-side photoelectric converter (optical transmission device), 101A transmission-side photoelectric converter (first moving device-side optical transmission device), 111A transmission-side photoelectric converter (head-side optical transmission device), 93B, 94B, 101B, 111B reception-side photoelectric converter (optical receiving device), 51A, 52A light emitting element (optical transmission device), 51B, 52B light receiving element (optical receiving device), 123 exchange message (notification information), 124, 128 work instruction message (notification information), 127 cleaning message (notification information), TH1 first threshold number, TH2 second threshold number

1. An optical communication device comprising:
an optical receiving device configured to execute optical communication using an optical signal;
a detection device configured to detect an error of data in received data received by the optical receiving device; and
a determination device configured to determine an increase in the number of times of detection of the error detected in the detection device, and make notification of notification information related to communication abnormality based on the determination that the number of times of detection has been increased.

2. The optical communication device according to claim 1, wherein the determination device determines whether the number of times of detection performed in the detection device within a predetermined time is equal to or greater than a threshold number, and determines that the number of times of detection has been increased when it is determined that the number of times of detection is equal to or greater than the threshold number.

3. The optical communication device according to claim 2,
wherein the optical receiving device is connected to an optical transmission device via a wired cable, and
the determination device makes notification of an exchange instruction for the wired cable as the notification information when the number of times of detection is equal to or greater than a first threshold number, and makes notification of a cleaning instruction for a connection portion of the wired cable as the notification information when the number of times of detection is equal to or greater than a second threshold number that is smaller than the first threshold number.

4. The optical communication device according to claim 1,
wherein, in the received data, multiple pieces of data are multiplexed, an error correction code is assigned to each of the multiple pieces of data,
the detection device executes error correction based on the error correction code for each of the multiple pieces of data separated from the received data, and
the determination device determines the increase in the number of times of detection using the number of times an error of at least one piece of data in the multiple pieces of data is corrected as the number of times of detection.

5. The optical communication device according to claim 4, wherein the determination device notifies a device that has processed, on a transmission side, data with the increased number of times of error correction among the multiple pieces of data, of the notification information for prompting execution of maintenance.

6. An operating machine comprising:
the optical communication device according to claim 1;
a head configured to perform work with respect to a workpiece;
a first moving device configured to move the head in a first movement direction;
a second moving device configured to move the head in a second movement direction different from the first movement direction;
a head-side optical transmission device connected to the optical receiving device via a first wired cable and provided in the head; and
a first moving device-side optical transmission device connected to the optical receiving device via a second wired cable and provided in the first moving device,
wherein the detection device detects an error of data in the received data received by the optical receiving device via each of the first wired cable and the second wired cable, and
the determination device individually determines the increase in the number of times of detection of the error detected in the detection device for each of the first wired cable and the second wired cable, and makes notification of the notification information.

7. A communication method in an operating machine including
the optical communication device according to claim 1,
a head configured to perform work with respect to a workpiece,
a first moving device configured to move the head in a first movement direction,
a second moving device configured to move the head in a second movement direction different from the first movement direction,
a head-side optical transmission device connected to the optical receiving device via a first wired cable and provided in the head, and
a first moving device-side optical transmission device connected to the optical receiving device via a second wired cable and provided in the first moving device,
the communication method comprising:
a detection step of detecting, with the detection device, an error of data in the received data received by the optical receiving device via each of the first wired cable and the second wired cable; and
a notification step of individually determining, with the determination device, the increase in the number of times of detection of the error detected in the detection device for each of the first wired cable and the second wired cable, and of making, with the determination device, notification of the notification information.
